(19) United States
(12) Patent Application Publication
(10) Pub. No.: US 2025/0280993 A1
(43) Pub. Date: Sep. 11, 2025

(54) BEVERAGE DISPENSING APPARATUS

(71) Applicant: FUJI ELECTRIC CO., LTD., Kawasaki-shi (JP)

(72) Inventors: Yuki FUJII, Yokkaichi-city (JP); Toshiyuki KAGEYAMA, Yokkaichi-city (JP)

(21) Appl. No.: 19/218,374

(22) Filed: May 26, 2025

Related U.S. Application Data
(63) Continuation of application No. PCT/JP2023/032712, filed on Sep. 7, 2023.

(30) Foreign Application Priority Data
Feb. 3, 2023 (JP) 2023-015256

(51) Int. Cl. A47J 31/60; A47J 31/46; A47J 31/52

(52) U.S. Cl. CPC A47J 31/60; A47J 31/468; A47J 31/52

(57) ABSTRACT

A beverage dispensing apparatus includes: an extraction unit extracting a beverage as an ingredient and hot water are fed; a nozzle that supplies the beverage extracted by the extraction unit to a container; and an addition-hot-water supply unit that supplies the hot water to the nozzle as addition hot water forming the beverage, without passing through the extraction unit.

### CROSS-REFERENCE TO RELATED APPLICATION(S)

This application is a continuation of International Application No. PCT/JP2023/032712, filed on Sep. 7, 2023 which claims the benefit of priority of the prior Japanese Patent Application No. 2023-015256, filed on Feb. 3, 2023, the entire contents of which are incorporated herein by reference.

### BACKGROUND

The present invention relates to a beverage dispensing apparatus.

In the related art, in beverage dispensing apparatuses that supply beverages to containers, an extraction unit arranged inside an apparatus main body extracts a beverage from a ground ingredient and hot water, and the extracted beverage is then dispensed into a container such as a cup (refer to Japanese Laid-open Patent Publication No. 2007-094869).

In the beverage dispensing apparatus described above, a conduit for supplying hot water for dilution (hereinafter, also referred to as “dilution hot water”) to a container is provided. This conduit supplies hot water stored in a hot water tank as dilution hot water to a dedicated dilution water nozzle without passing through an extraction unit, and the dilution hot water is then dispensed into the container from the nozzle.

### SUMMARY

There is a need for providing a beverage dispensing apparatus that enables preferable cleaning of a nozzle that dispenses a beverage extracted by an extraction unit.

According to an embodiment, a beverage dispensing apparatus according to the present invention includes an extraction unit extracting a beverage as an ingredient and hot water are fed, and that supplies the beverage extracted by the extraction unit to a container through a nozzle. Further, the beverage dispensing apparatus further includes: an addition-hot-water supply unit that supplies the hot water to the nozzle as addition hot water forming the beverage, without passing through the extraction unit.

### BRIEF DESCRIPTION OF DRAWINGS

FIG. 1 is a perspective view illustrating an external configuration of a beverage dispensing apparatus that is an embodiment of the present invention;

FIG. 2 is a exploded perspective view of the beverage dispensing apparatus that is an embodiment of the present invention;

FIG. 3 is a schematic diagram schematically illustrating respective components of the beverage dispensing apparatus that is an embodiment of the present invention;

FIG. 4 is a schematic diagram schematically illustrating a connection state of a beverage dispensing conduit and an addition-water supply conduit in FIG. 3;

FIG. 5 is an explanatory diagram illustrating an extraction procedure of a beverage by the beverage dispensing apparatus illustrated in FIG. 1 to FIG. 3;

FIG. 6 is an explanatory diagram illustrating an extraction procedure by the beverage dispensing apparatus illustrated in FIG. 1 to FIG. 3;

FIG. 7 is an explanatory diagram illustrating an extraction procedure by the beverage dispensing apparatus illustrated in FIG. 1 to FIG. 3;

FIG. 8 is an explanatory diagram illustrating an extraction procedure by the beverage dispensing apparatus illustrated in FIG. 1 to FIG. 3;

FIG. 9 is an explanatory diagram illustrating an extraction procedure by the beverage dispensing apparatus illustrated in FIG. 1 to FIG. 3;

FIG. 10 is an explanatory diagram illustrating an extraction procedure by the beverage dispensing apparatus illustrated in FIG. 1 to FIG. 3; and

FIG. 11 is an explanatory diagram illustrating an extraction procedure by the beverage dispensing apparatus illustrated in FIG. 1 to FIG. 3.

### DETAILED DESCRIPTION

In the related-art beverage dispensing apparatus, because the dilution hot water has been supplied from a dedicated dilution hot water nozzle that is separate from a nozzle dispensing a beverage extracted by the extraction unit, it has been impossible to clean the nozzle.

Hereinafter, exemplary embodiments of a beverage dispensing apparatus according to the present invention will be explained in detail with reference to the accompanying drawings.

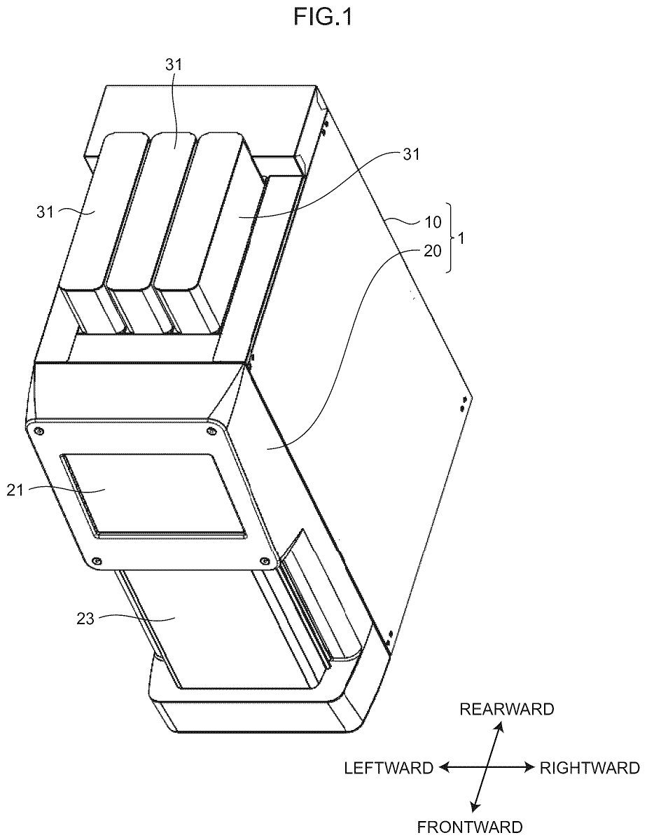

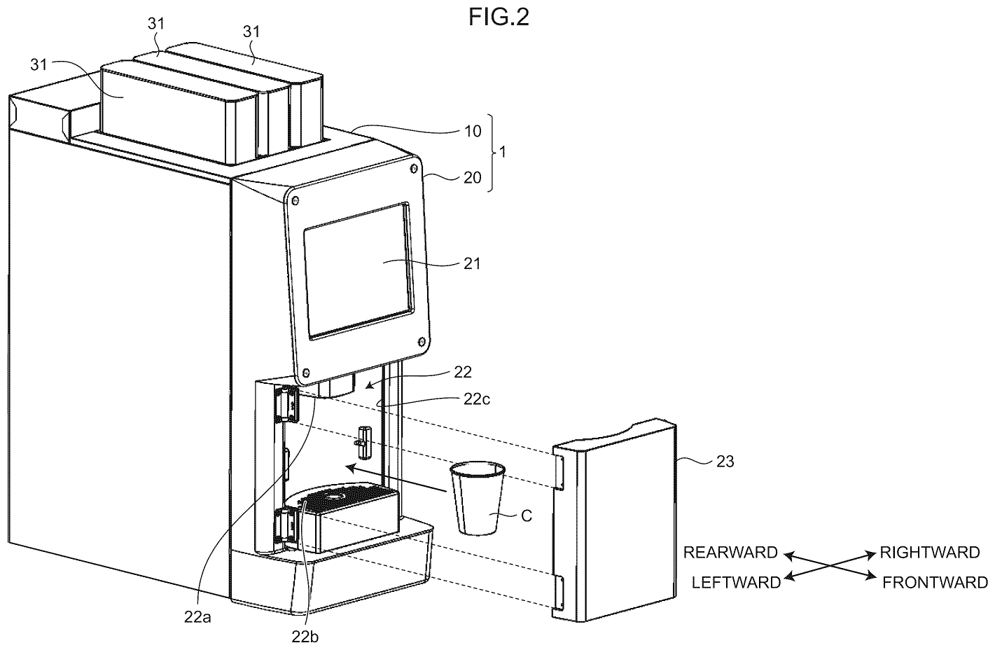

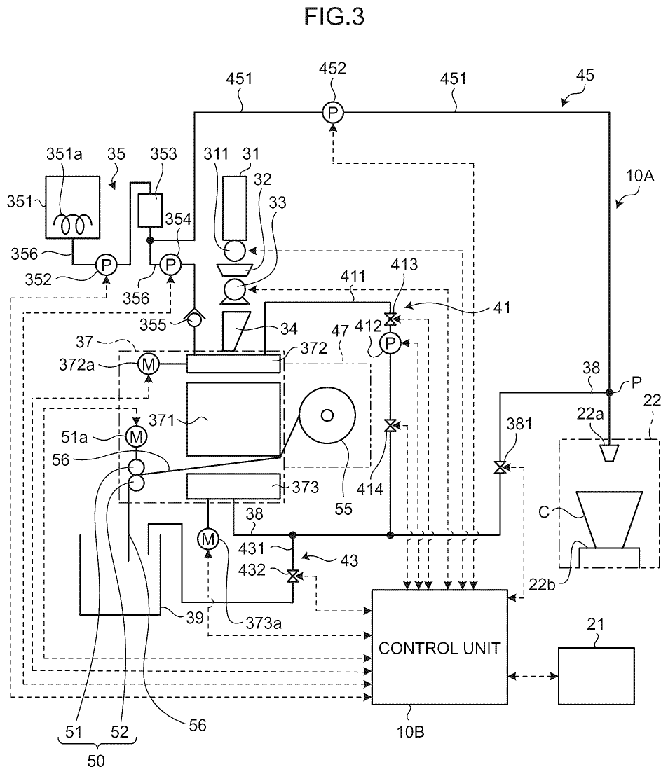

FIG. 1 to FIG. 3 respectively illustrate the beverage dispensing apparatus that is an embodiment of the present invention. FIG. 1 is a perspective view illustrating an external configuration, FIG. 2 is an exploded perspective view, and FIG. 3 is a schematic diagram schematically illustrating respective components.

The beverage dispensing apparatus illustrated herein is, for example, a coffee machine installed in stores such as convenience stores, that performs extraction processing such as grinding coffee beans and dripping, and supplies beverages such as coffee to a container C, such as a cup. Such a beverage dispensing apparatus includes an apparatus main unit 1.

The apparatus main unit 1 is configured to include a main unit cabinet 10 and a front door 20. The main unit cabinet 10 has a substantially rectangular prism shape with an opening (hereinafter, also referred to as “front opening”) on its front not illustrated. Inside this main unit cabinet 10, a beverage production unit 10A that makes a beverage (for example, coffee) and a control unit 10B are arranged.

The front door 20 is a door unit that is in a size large enough to close the front opening of the main unit cabinet 10. This front door 20 is arranged swingably around a center axis of an axial portion not illustrated that extends along a vertical direction at a left edge portion on a front side of the main unit cabinet 10, and is capable of opening and closing the front opening of the main unit cabinet 10.

In the front door 20, its front side forms a customer-facing side, and is provided with a display unit 21, a beverage dispensing unit 22, and an opening/closing door 23.

The display unit 21 is constituted of, for example, a liquid crystal touch panel, and is configured to display various kinds of information according to an instruction provided by the control unit 10B, and to enable input operation, such as touch operation. The display unit 21 transmits a purchase signal to the control unit 10B when an input operation, such as a touch operation, is performed.

The beverage dispensing unit 22 is arranged below the display unit 21, and includes a nozzle 22a and a stage 22b. The nozzle 22a discharges a beverage produced by the beverage production unit 10A downward. More specifically, the nozzle 22a is a diffuser nozzle that stores the beverage sent to itself once, and then discharges it downward. The stage 22b is arranged in an area below the nozzle 22a. This stage 22b is to put the container C thereon.

The opening/closing door 23 is made of a translucent material such as transparent resin, and is in a size large enough to close an inlet 22c of the beverage dispensing unit 22. The opening/closing door 23 is pivotally supported by the front door 20 at its left end portion, and is swingable along the front-rear direction. That is, the opening/closing door 23 is swingable along the front-rear direction in such a manner that it moves toward and away from the beverage dispensing unit 22. The opening/closing door 23 can close the inlet 22c of the beverage dispensing unit 22 when it swings rearward to approach the beverage dispensing unit 22, and can open the inlet 22c of the beverage dispensing unit 22 when it swings forward to move away from the beverage dispensing unit 22.

The beverage production unit 10A described above will be explained. The beverage production unit 10A includes an ingredient storage unit 31, a grinder 33, a hot-water supply unit 35, an extraction unit 37, a collection bucket 39, a compressed-air supply unit 41, a drainage unit 43, and an addition-hot-water supply unit 45.

The ingredient storage unit 31 is to store roasted coffee beans, which are a beverage ingredient, and is arranged in such a manner that a part thereof extends upward from a top panel of the main unit cabinet 10. This ingredient storage unit 31 includes an ingredient-supply driving unit 311. The ingredient-supply driving unit 311 operates when a drive instruction is given from the control unit 10B, and dispenses a predetermined amount of coffee beans specified in the drive instruction.

The grinder 33 is a so-called mill, and operates when a drive instruction is given by the control unit 10B. This grinder 33 is arranged at an area below the ingredient storage unit 31, and is connected to the ingredient storage unit 31 through an ingredient chute 32.

The grinder 33 grinds, when operating, coffee beans that has been dispensed from the ingredient storage unit 31 and guided thereto by the ingredient chute 32, and feeds the ground coffee beans (hereinafter, also referred to as ground coffee) into the extraction unit 37 through a powder chute 34.

The hot-water supply unit 35 supplies hot water to the extraction unit 37, and is constituted of a hot water tank 351, a metering pump 352, a sub-tank 353, a hot-water supply pump 354, and a check valve 355 sequentially connected to a hot-water supply conduit 356 constituted by hot-water supply piping.

The hot water tank 351 heats water, such as tap water, supplied from a water supply means not illustrated using a heater 351a, and stores it as hot water. The metering pump 352 is constituted by a non-positive displacement pump, such as a centrifugal pump. The metering pump 352 is driven in response to an instruction from the control unit 10B, and when driven, sends a specified amount of hot water from the hot water tank 351 to the sub-tank 353. The sub-tank 353 is smaller in volume than the hot water tank 351, and temporarily stores the hot water sent by the metering pump 352. The hot-water supply pump 354 is constituted by a positive displacement pump, such as a gear pump. This hot-water supply pump 354 is driven in response to an instruction from the control unit 10B, and when driven, compresses the hot water in the sub-tank 353 and sends it to the extraction unit 37. The hot-water supply pump 354 is configured such that its discharge amount is larger than the discharge amount of the metering pump 352. The check valve 355 is a valve body that allows hot water sent from the hot-water supply pump 354 to pass toward the extraction unit 37, while restricting passage of hot water from the extraction unit 37 to the sub-tank 353. Although not explicitly illustrated in the drawing, the check valve 355 is arranged in a state thermally connected to the hot water tank 351.

The extraction unit 37 is a so-called brew unit, and extracts coffee from the ground coffee fed from the grinder 33 through the power chute 34 and hot water supplied by the hot water supply unit 35.

To the extraction unit 37 as described, a beverage supply conduit 38 is connected. The beverage supply conduit 38 is constituted of a single beverage supply conduit, or constituted by connecting multiple beverage supply conduits, and supplies coffee extracted by the extraction unit 37 to the nozzle 22a.

In this beverage supply conduit 38, a first pinch valve 381 is arranged in the middle. This first pinch valve 381 opens and closes in response to an instruction given by the control unit 10B, and allows fluid to flow when it is in an open state, while restricting passage of fluid when it is in a closed state.

The extraction unit 37 described above includes a cylinder 371, a lid 372, and a filter block 373. The cylinder 371 has a substantially cylindrical shape, and is arranged detachably with respect to the main unit cabinet 10.

The lid 372 moves in such a manner that it approaches and retracts from an upper opening of the cylinder 371 as the lid 372, such as a motor, drives in response to an instruction given by the control unit 10B, thereby opening and closing the upper opening of the cylinder 371. Although not illustrated, in the lid 372, a hole that allows ground coffee supplied through the power chute 34 to be put into the cylinder 371, and a hole that allows hot water supplied by the hot-water supply unit 35 to be put into the cylinder are formed.

The filter block 373 is arranged in an area below the cylinder 371, and is connected to the beverage supply conduit 38 described above. This filter block 373 moves in a vertical direction in such a manner that it approaches and retracts from the cylinder 371 as a block drive unit 373a, such as a motor, drives in response to an instruction given by the control unit 10B.

The extraction unit 37 includes a paper roller 50. The paper roller 50 holds a paper filter 56 that is drawn out from a filter roll 55 that is rotatably supported and housed in a filter storage unit 47. The paper roller 50 is constituted of a drive roller 51 and a driven roller 52.

The drive roller 51 rotates around its center axis when a roller driving unit 51a, which is a driving source, drives in response to an instruction from the control unit 10B.

The driven roller 52 rotates around its center axis as the drive roller 51 rotates, by sandwiching the paper filter 56 between a portion of an outer periphery thereof and a corresponding portion of an outer periphery of the drive roller 51.

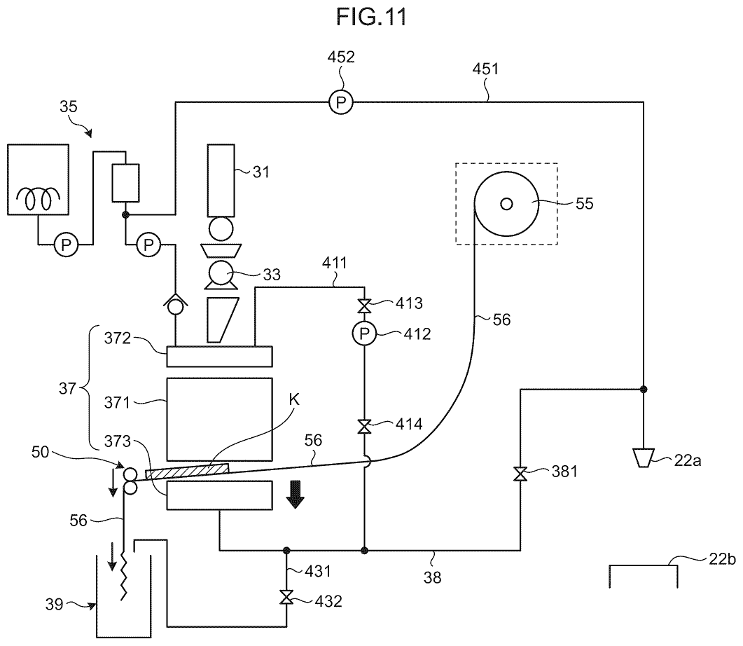

The collection bucket 39 is arranged in an area below the extraction unit 37, and stores an extraction residue K (refer to FIG. 11) generated during extraction of a beverage in the extraction unit 37, together with the paper filter 56.

The compressed-air supply unit 41 includes a compressed-air supply conduit 411, an air pump 412, a second pinch valve 413, and a third pinch valve 414.

The compressed-air supply conduit 411 is formed by connecting multiple compressed-air supply conduits, and its one end is connected to the lid 372 and the other end is connected to a middle portion of the beverage supply conduit 38.

The air pump 412 is provided in the compressed-air supply conduit 411. This air pump 412 is driven in response to an instruction from the control unit 10B and compresses air to send it out.

The second pinch valve 413 is arranged on one end side (the lid 372 side) relative to the air pump 412 in the compressed-air supply conduit 411. This second pinch valve 413 opens and closes in response to an instruction given by the control unit 10B, and allows passage of fluid when it is in an open state, while restricting passage of fluid when it is in the closed state.

The third pinch valve 414 is arranged on the other side to the air pump 412 (on the beverage supply conduit 38 side) in the compressed-air supply conduit 411. This third pinch valve 414 opens and closes in response to an instruction given by the control unit 10B, and allows passage of fluid when it is in an open state, while restricting passage of fluid when it is in the closed state.

The drainage unit 43 includes a drainage conduit 431 and a fourth pinch valve 432. The drainage conduit 431 is formed by connecting one or more drainage pipes, and is arranged in such a manner that it branches from a middle portion of the beverage supply conduit 38 and extends into an area above the collection bucket 39.

The fourth pinch valve 432 is arranged in the drainage conduit 431. This fourth pinch valve 432 opens and closes in response to an instruction given by the control unit 10B, and allows passage of fluid such as waste liquid when it is in an open state, while it restricts passage of fluid such as waste liquid when it is in a closed state. Thus, the collection bucket 39 stores the extraction residue K generated during extraction of a beverage in the extraction unit 37, the paper filter 56 used in the extraction of the beverage, and waste liquid generated by the cleaning of the extraction unit 37.

The addition-hot-water supply unit 45 includes an addition-hot-water supply conduit 451 and an addition-hot-water pump 452. The addition-hot-water supply conduit 451 is formed by connecting multiple addition-hot-water supply conduits, and its one end is connected to a portion between the sub-tank 353 and the hot-water supply pump 354 in the hot-water supply conduit 356, and the other end is connected to a junction point P between the first pinch valve 381 and the nozzle 22a in the beverage supply conduit 38.

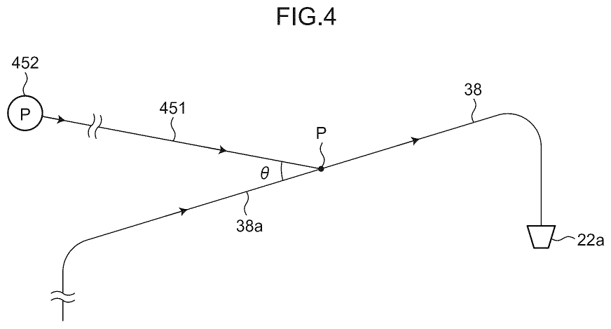

Connection of the addition-hot-water supply conduit 451 and the beverage supply conduit 38 will be explained. As illustrated in FIG. 4, between the first pinch valve 381 and the nozzle 22a in the beverage supply conduit 38, an inclined extending portion 38a that gradually extends upward toward the nozzle 22a is provided, and the junction point P described above is formed in this inclined extending portion 38a.

On the other hand, the addition-hot-water supply conduit 451 inclines gradually downward as it approaches the inclined extending portion 38a, and is connected to the junction point P in such a manner that an angle θ formed with the inclined extending portion 38a is an acute angle, that is, an acute angle with respect to a direction in which coffee (beverage) is supplied in the inclined extending portion 38a.

The addition-hot-water pump 452 is arranged on the addition-hot-water supply conduit 451. This addition-hot-water pump 452 is constituted by a positive displacement pump, such as a diaphragm pump, and is driven in response to an instruction given by the control unit 10B. The addition-hot-water pump 452 sends out hot water in the sub-tank 353 as addition hot water forming coffee to the nozzle 22a through the addition-hot-water supply conduit 451 when driving, while it restricts sending addition water to the nozzle 22a through the addition-hot-water supply conduit 451 when the driving is stopped.

The control unit 10B comprehensively controls operation of the respective components of the beverage dispensing apparatus according to a program or data stored in the storage unit not illustrated.

The control unit 10B may be implemented by causing a processing device, such as a central processing unit (CPU), to execute a program, that is, by software, may be implemented by hardware, such as an integrated circuit (IC), or may be implemented by using software and hardware.

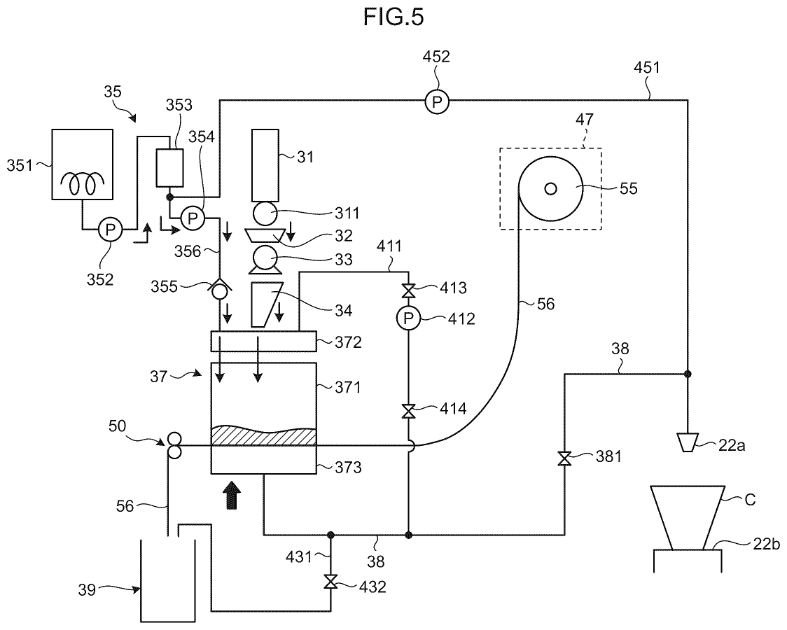

In the beverage dispensing apparatus configured as described above, as illustrated in FIG. 5 to FIG. 11, coffee is supplied to the container C placed on stage 22b of the beverage dispensing unit 22. As a premise, it is assumed that hot water at a predetermined temperature is generated and stored in the hot water tank 351, and the first pinch valve 381, the second pinch valve 413, and the fourth pinch valve 432 are in the closed state, while the third pinch valve 414 is in the open state.

As the display unit 21 is operated by touch operation by a user, the control unit 10B to which a purchase signal of a selected beverage is given moves the filter block 373 upward as illustrated in FIG. 5, and then sends a drive instruction to the ingredient-supply driving unit 311 to feed an amount of coffee beans suitable for the beverage to the grinder 33, and sends a drive instruction to the grinder 33 to grind the coffee beans and put into the extraction unit 37. Thereafter, it stops driving of the ingredient-supply driving unit 311.

The control unit 10B drives the metering pump 352 to send a specific amount of hot water from the hot water tank 351 to the sub-tank 353, while driving the hot-water supply pump 354 to compress the hot water in the sub-tank 353 and send it to the extraction unit 37, thereby putting hot water to the extraction unit 37. Thereafter, the driving of the metering pump 352 and the hot-water supply pump 354 is stopped.

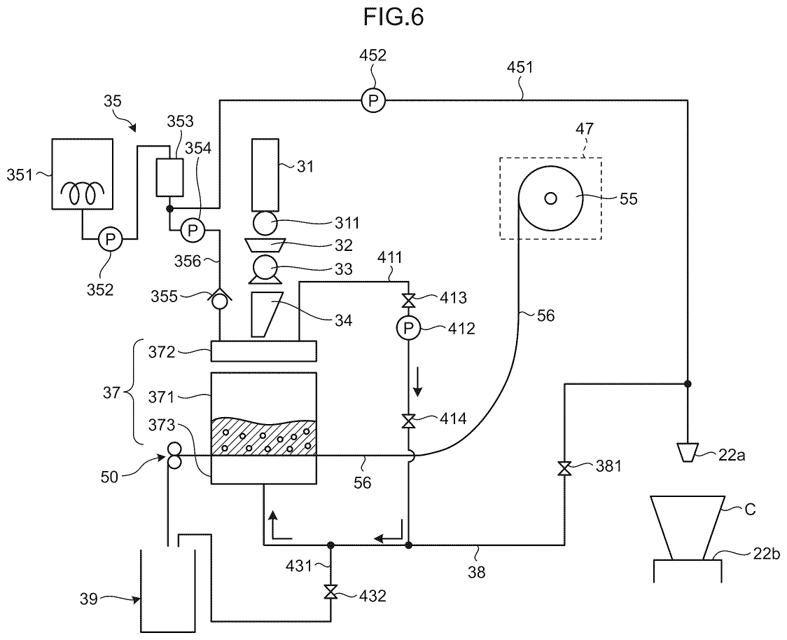

The control unit 10B then drives the air pump 412 to supply compressed air (compressed air for stirring) to the cylinder 371 to stir (forcibly stir) the ground coffee and hot water using a part of the beverage supply conduit 38 as illustrated in FIG. 6. Thereafter, the driving of the air pump 412 is stopped.

The control unit 10B that has forcibly stirred the ground coffee and hot water as described moves the lid 372 to close the upper opening of the cylinder 371, brings the third pinch valve 414 into the closed state, brings the first pinch valve 381 and the second pinch valve 413 into the open state, and drives the air pump 412. The fourth pinch valve 432 is maintained in the closed state.

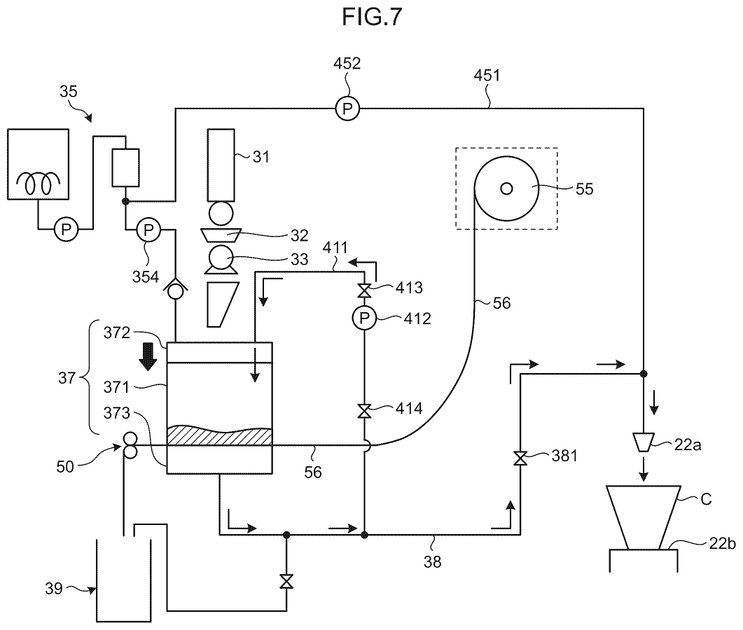

Thus, as illustrated in FIG. 7, coffee is extracted by supplying compressed air (compressed air for extraction) to the cylinder 371, and the extracted coffee is supplied to the nozzle 22a through the beverage supply conduit 38, and is dispensed to the container C from the nozzle 22a.

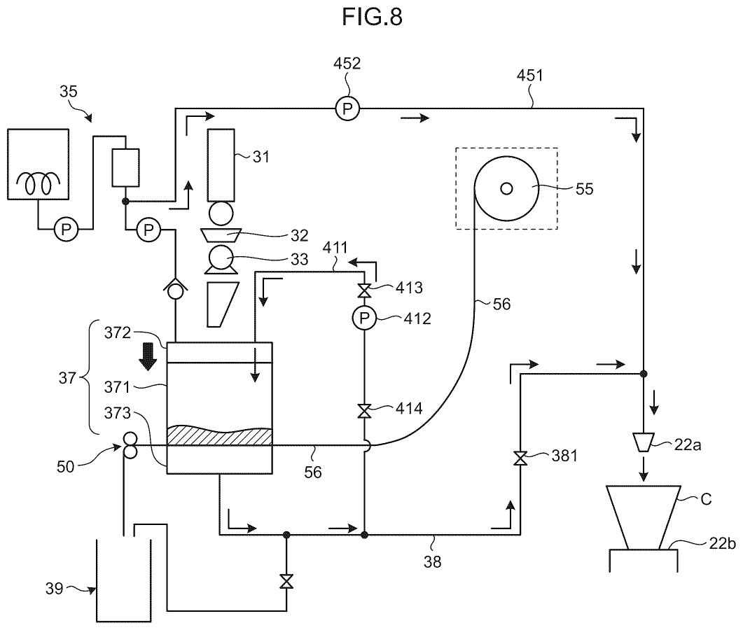

The control unit 10B then drives the addition-hot-water pump 452. Thus, as illustrated in FIG. 8, hot water in the sub-tank 353 is sent out to the nozzle 22a through the addition-wat-water supply conduit 451 as the addition hot water, and the addition hot water is dispensed to the container C as an element forming coffee.

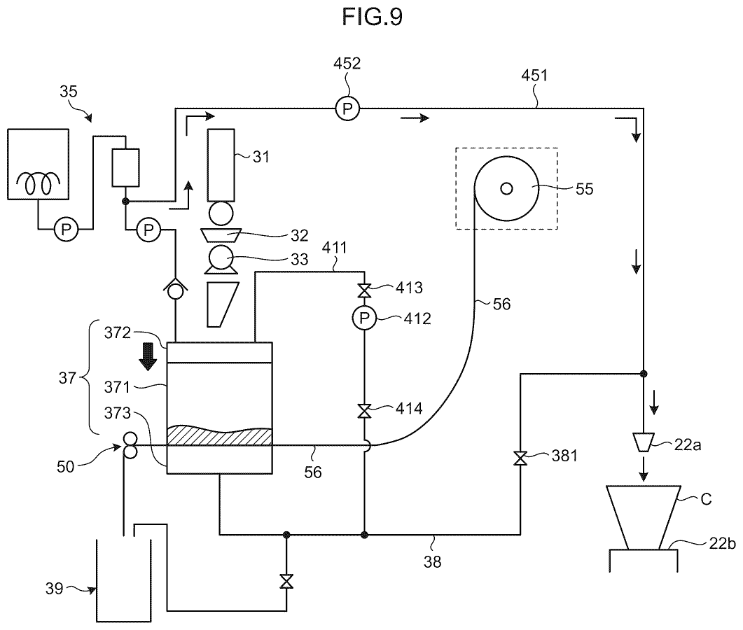

After the discharge of the coffee extracted by the extraction unit 37 into the container C is completed, the control unit 10B stops the driving of the air pump 412 but continues the driving of the addition-hot-water pump 452. Thus, as illustrated in FIG. 9, the hot water in the sub-tank 353 is discharged as addition hot water from the nozzle 22a into the container C through the addition-hot-water supply conduit 451.

When a predetermined amount of coffee is discharged and supplied into the container C, the control unit 10B stops the driving of the addition-hot-water pump 452. Thus, the user can take out the container C from the beverage dispensing unit 22 by swinging the opening/closing door 23 in the opening direction.

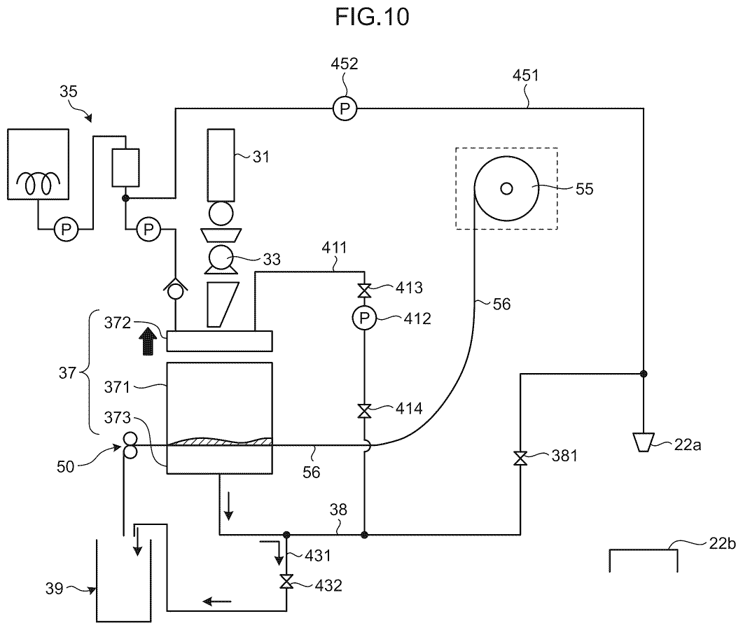

Thereafter, the control unit 10B moves the lid 372 to open the upper opening of the cylinder 371, to release the internal pressure in the cylinder 371. The control unit 10B then supplies hot water form the hot-water supply unit 35 to the extraction unit 37, to clean an interior of the cylinder 371, and brings the fourth pinch valve 432 into the open state, to discharge remaining water in the extraction unit 37 as waste fluid into the collection bucket 39 through the drainage conduit 431 as illustrated in FIG. 10.

The control unit 10B that has discharged the waste fluid as described brings the fourth pinch valve 432 into the closed state as illustrated in FIG. 11, and moves the filter block 373 downward. The control unit 10B makes the paper roller 50 to feed out the paper filter 56 by a predetermined amount, causes the collection bucket 39 to collect the residue K generated by extraction of coffee together with the paper filter 56, and ends dispensing of coffee this time.

As explained above, according to the beverage dispensing apparatus that is an embodiment of the present invention, hot water is supplied to the nozzle 22a as addition hot water by the addition-hot-water supply unit 45 without passing through the extraction unit 37. Therefore, the nozzle 22a that dispenses a beverage extracted by the extraction unit 37 can be cleaned with the addition hot water supplied as a beverage. Accordingly, the nozzle 22a that dispenses a beverage extracted by the extraction unit 37 can be preferably cleaned.

Particularly, because the control unit 10B drives the addition-hot-water pump 452 also after extraction of coffee by the extraction unit 37, the nozzle 22a can be cleaned reliably with the addition hot water.

Moreover, according to the beverage dispensing apparatus, because the addition hot water constituting a beverage is supplied to the container C, the addition water is not mixed with ground coffee, and there is no risk of extracting components of strange flavor or the like, thereby suppressing degradation of the quality of the coffee supplied to the container C.

Furthermore, according to the beverage supply apparatus, because the addition-hot-water supply conduit 451 is gradually inclined downward as it approaches the inclined extending portion 38a of the beverage supply conduit 38 and is connected to form an acute angle with respect to the direction in which coffee is supplied in the inclined extending portion 38a, it is possible to prevent coffee from flowing backward to the addition-hot-water supply conduit 451 when coffee is supplied to the nozzle 22a through the beverage supply conduit 38.

As above, an exemplary embodiment of the present invention has been explained, but the present invention is not limited thereto, and various modifications can be made.

In the embodiment described above, the addition-hot-water pump 452 is driven also after extraction of coffee, but in the present invention, the driving timing can be arbitrarily set.

Moreover, in the present invention, even when a beverage discharged from the nozzle 22a is only coffee extracted by the extraction unit 37 and supply of addition hot water from the addition-hot-water supply unit 45 is not necessary, the addition-hot-water pump 452 may be driven.

This enables to supply remaining hot water or the like in the addition-hot-water supply conduit 451 to the nozzle 22a.

According to the present invention, because an addition-water supply unit supplies hot water as addition hot water that forms a beverage to a nozzle without passing through an extraction unit, the nozzle that dispenses the beverage extracted by the extraction unit can be cleaned by the addition water supplied as the beverage. Therefore, an effect of enabling preferable cleaning of the nozzle that dispenses the beverage extracted by the extraction unit is produced.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A beverage dispensing apparatus comprising:
an extraction unit extracting a beverage as an ingredient and hot water are fed;
a nozzle that supplies the beverage extracted by the extraction unit to a container; and
an addition-hot-water supply unit that supplies the hot water to the nozzle as addition hot water forming the beverage, without passing through the extraction unit.

2. The beverage dispensing apparatus according to claim 1, wherein
the addition-hot-water supply unit includes
an addition-hot-water supply conduit to supply the addition hot water to the nozzle; and
an addition-hot-water pump that is arranged in the addition-hot-water supply conduit, and that sends the addition hot water to the nozzle through the addition-hot-water supply conduit when driven, while restricting sending the addition hot water to the nozzle through the addition-hot-water supply conduit when the driving is stopped.

3. The beverage dispensing apparatus according to claim 2, further comprising
a control unit that drives the addition-hot-water pump also after extraction of the beverage by the extraction unit.

4. The beverage dispensing apparatus according to claim 2, further comprising
a beverage supply conduit that supplies a beverage extracted by the extraction unit to the nozzle, and that has an inclined extending portion that extends in a gradually inclined manner upward toward the nozzle, wherein
the addition-hot-water supply conduit is connected in such a manner that it gradually inclined downward as it approaches the inclined extending portion, and forms an acute angle with respect to a direction in which a beverage is supplied in the inclined extending portion.

5. The beverage dispensing apparatus according to claim 3, further comprising
a beverage supply conduit that supplies a beverage extracted by the extraction unit to the nozzle, and that has an inclined extending portion that extends in a gradually inclined manner upward toward the nozzle, wherein
the addition-hot-water supply conduit is connected in such a manner that it gradually inclined downward as it approaches the inclined extending portion, and forms an acute angle with respect to a direction in which a beverage is supplied in the inclined extending portion.
